(19) United States
(12) Patent Application Publication
(10) Pub. No.: US 2021/0356795 A1
(43) Pub. Date: Nov. 18, 2021

(54) DUAL-MODE MULTI-CONJUGATE FILTER BASED ON TWO DIFFERENT VOLTAGE DRIVEN SCHEMES

(71) Applicant: CHEMIMAGE CORPORATION, Pittsburgh, PA (US)

(72) Inventors: Lei SHI, Wexford, PA (US); George VENTOURIS, Valley City, OH (US); Matthew P. NELSON, Harrison City, PA (US); Patrick J. TREADO, Pittsburgh, PA (US)

(21) Appl. No.: 17/322,808

(22) Filed: May 17, 2021

Related U.S. Application Data
(60) Provisional application No. 63/026,213, filed on May 18, 2020.

(51) Int. Cl. G02F 1/1347; G02B 27/28; G02F 1/139

(52) U.S. Cl. CPC G02F 1/13473; G02B 27/288; G02F 2202/40; G02F 2203/055; G02F 1/1393

(57) ABSTRACT

A multi-conjugate filter (MCF) can be operated in both a single bandpass mode and a multiple bandpass mode. By applying different voltages to different channels of a MCF, the MCF can be used to filter light into (1) a single narrow spectral output or (2) a broad ranged “white light” spectral output.

### CROSS-REFERENCE TO RELATED APPLICATIONS

The present application claims priority to U.S. Provisional Patent Application No. 63/026,213, titled DUAL-MODE MULTI-CONJUGATE FILTER BASED ON TWO DIFFERENT VOLTAGE DRIVEN SCHEMES, filed May 18, 2020, which is hereby incorporated by reference herein in its entirety.

### TECHNICAL FIELD

Multi-conjugate filters (MCF) are optically tunable filters that are used in the field of hyper spectral imaging (HSI). Known MCF are typically operated in single bandpass mode, similar to the operation of an optical bandpass filter (BPF). In single bandpass mode, when a broad range of light passes through the LCTF and/or MCF, only a single band (i.e., the commanded wavelength range) of that light is permitted to pass through the MCF. MCF that are operated in single bandpass mode must (1) accurately permit only light of the commanded wavelength range to pass through the MCF, (2) minimize the absorption or loss of light spectra within the commanded wavelength range through the MCF, and (3) minimize the leakage of light spectra outside the commanded wavelength range through the MCF.

Although operation of MCF in single bandpass mode is useful, there is a need for more complex modes of operation to provide greater functionality for an optical device based on MCF technology. It would be beneficial if, in addition to operating in single bandpass mode, the MCF could operate in multiple bandpass mode. The present disclosure is directed to this and other advantageous improvements to MCF.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. In the drawings:

FIG. 1 depicts a MCF in accordance with the present disclosure.

FIG. 2A depicts the simulated spectral output of a MCF channel having a 1000 μm thickness quartz retarder and a voltage of 2.0 V applied to the liquid crystal in accordance with the present disclosure.

FIG. 2B depicts the simulated spectral output of a MCF channel having a 1000 μm thickness quartz retarder and a voltage of 4.5 V applied to the liquid crystal in accordance with the present disclosure.

FIG. 3A depicts the uncorrected phase profile of the simulated spectral output of a MCF channel having a 1000 μm quartz retarder thickness and a voltage of 2.0 V applied to the liquid crystal in accordance with the present disclosure.

FIG. 3B depicts the uncorrected phase profile of the simulated spectral output of a MCF channel having a 1000 μm quartz retarder thickness and a voltage of 4.5 V applied to the liquid crystal in accordance with the present disclosure.

FIG. 4A depicts the corrected phase profile of the simulated spectral output of a MCF channel having a 1000 μm quartz retarder thickness and a voltage of 2.0 V applied to the liquid crystal in accordance with the present disclosure.

FIG. 4B depicts the corrected phase profile of the simulated spectral output of a MCF channel having a 1000 μm quartz retarder thickness and a voltage of 4.5 V applied to the liquid crystal in accordance with the present disclosure.

FIG. 5 depicts the simulated spectral output of a MCF where a first voltage of 2.0 V is applied to a first liquid crystal and a second voltage of 4.5 V is applied to a second liquid crystal in accordance with the present disclosure.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The embodiments of the present teachings described below are not intended to be exhaustive or to limit the teachings to the precise forms disclosed in the following detailed description. Rather, the embodiments are chosen and described so that others skilled in the art may appreciate and understand the principles and practices of the present teachings.

### The Multi-Conjugate Filter (MCF)

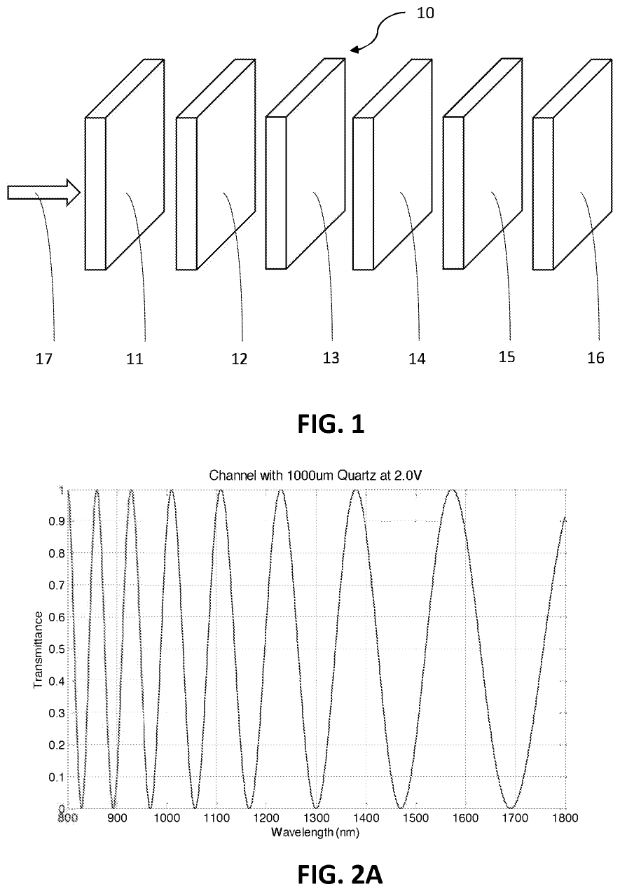

A MCF that is capable of operating both in (1) single bandpass mode and (2) multiple bandpass mode is depicted in FIG. 1. As shown in FIG. 1, MCF stage 10 contains six optical elements, represented by the six two-dimensional sheets in FIG. 1. In MCF stage 10, light 17 first passes through the entrance polarizer 11 having an optical axis of 0°. Next, the light 17 passes to a first liquid crystal 12 having an optical axis of +23°, followed by a first fixed quartz retarder 13 having an optical axis of +23°. After the first fixed quartz retarder 13, the light 17 passes through a second quartz retarder 14 having an optical axis of −23°, followed by a second liquid crystal 15 having an optical axis of −23°. Finally, the light 17 exits the MCF by passing through the analyzer polarizer 16 having an optical axis of 90°.

The MCF stage 10 depicted in FIG. 1 has two “channels” in the stage, with the first channel having an optical axis of −23° and the second channel having an optical axis of +23°. In the embodiment of FIG. 1, the first channel and the second channel are arranged in that sequence. In FIG. 1, the first channel includes first liquid crystal 12 and first fixed quartz retarder 13; the second channel includes second quartz retarder 14 and second liquid crystal 15.

The stages of the MCF are not limited in their construction. In some embodiments, each stage includes one or more retarders that alter the polarization state of the light that travels through the retarders. The retarder can be constructed of any birefringent material that is capable of polarizing the light. Examples of birefringent materials include one or more of quartz, mica, and plastic.

The thickness of the birefringent material is also selected based on the required polarization of the light and is not limited. In some embodiments, the thickness is about 0.1 mm to about 4.5 mm. In other embodiments, the thickness of the birefringent material is about 0.1 mm to about 4.5 mm, including about 0.2 mm, about 0.3 mm, about 0.4 mm, about 0.5 mm, about 0.6 mm, about 0.7 mm, about 0.8 mm, about 0.9 mm, about 1.0 mm, about 1.1 mm, 1.2 mm, about 1.3 mm, about 1.4 mm, about 1.5 mm, about 1.6 mm, about 1.7 mm, about 1.8 mm, about 1.9 mm, about 2.0 mm, about 2.1 mm, 2.2 mm, about 2.3 mm, about 2.4 mm, about 2.5 mm, about 2.6 mm, about 2.7 mm, about 2.8 mm, about 2.9 mm, about 3.0 mm, about 3.1 mm, 3.2 mm, about 3.3 mm, about 3.4 mm, about 3.5 mm, about 3.6 mm, about 3.7 mm, about 3.8 mm, about 3.9 mm, about 4.0 mm, about 4.1 mm, about 4.2 mm, about 4.3 mm, about 4.4 mm, about 4.5 mm, or any range formed by the above values as endpoints.

### Operation of the MCF

The operation of the MCF of the disclosure is described by way of Jones calculus. The state of any polarization is described with a two-element Jones vector, and the linear operation of any optical element is represented by a 2×2 Jones matrix. Referring again to FIG. 1, the incident beam from the entrance polarizer 11 is represented by Formula 1, where E₁ is a complex amplitude:

$${E}_{1} = \frac{1}{\sqrt{2}} ( \begin{matrix}0 \\ 1\end{matrix} ) \qquad ( 1 )$$

The Jones matrix for the first channel is represented by Formula 2, where E_{Ch1} represents the complex amplitude of the first channel:

$${E}_{C h 1} = ( \begin{matrix}cos ( \frac{π}{8} ) & - sin ( \frac{π}{8} ) \\ sin ( \frac{π}{8} ) & cos ( \frac{π}{8} )\end{matrix} ) \cdot ( \begin{matrix}{e}^{- i \frac{δ 1}{2}} & 0 \\ 0 & {e}^{i \frac{δ 1}{2}}\end{matrix} ) \cdot ( \begin{matrix}cos ( \frac{π}{8} ) & sin ( \frac{π}{8} ) \\ - sin ( \frac{π}{8} ) & cos ( \frac{π}{8} )\end{matrix} ) \qquad ( 2 )$$

The Jones matrix for the second channel is represented by Formula 3.

$${E}_{C h 2} = ( \begin{matrix}cos ( \frac{π}{8} ) & sin ( \frac{π}{8} ) \\ - sin ( \frac{π}{8} ) & cos ( \frac{π}{8} )\end{matrix} ) \cdot ( \begin{matrix}{e}^{- i \frac{δ 2}{2}} & 0 \\ 0 & {e}^{i \frac{δ 2}{2}}\end{matrix} ) \cdot ( \begin{matrix}cos ( \frac{π}{8} ) & - sin ( \frac{π}{8} ) \\ sin ( \frac{π}{8} ) & cos ( \frac{π}{8} )\end{matrix} ) \qquad ( 3 )$$

The Jones matrix for the analyzer is represented by Formula 4.

$$T = {sin}^{2} ( \frac{δ 1}{2} ) {sin}^{2} ( \frac{δ 2}{2} ) + \frac{1}{2} {sin}^{2} ( \frac{δ 1 - δ 2}{2} ) \qquad ( 4 )$$

In one embodiment, the MCF operates in single bandpass mode by applying the same voltage or substantially the same voltage to the first liquid crystal 12 of the first channel as is applied to the second liquid crystal 15 of the second channel. When the same voltage or substantially the same voltage is applied to the first liquid crystal 12 and the second liquid crystal 15, both the first liquid crystal 12 and the second liquid crystal 15 exhibit the same degree of axial twist of the light 17 that passes through the first liquid crystal 12 and the second liquid crystal 15. The configuration of each liquid crystal 12, 15 is such that in an OFF (0 V) state, the light 17 that passes through the liquid crystal is rotated 90° by the twisted liquid crystal molecules. When voltage is applied in an ON state, the liquid crystal molecules become aligned and permit light 17 to pass through diminished or even zero rotation.

When the MCF operates in the single bandpass mode, the phase retardation profile δ₁ of the first channel is expected to be equal to the phase retardation profile δ₂ of the second channel. As a result, in Formula 4, the second term of

$$\frac{1}{2} {sin}^{2} ( \frac{δ 1 - δ 2}{2} )$$

is equal to zero. The first term

$${sin}^{2} ( \frac{δ 1}{2} ) {sin}^{2} ( \frac{δ 2}{2} )$$

of Formula 4 is the product of two Lyot equivalent stages having the same phase retardation.

In another embodiment, the MCF operates in multiple bandpass mode. In multiple bandpass mode, the voltages applied to the first liquid crystal 12 and the second liquid crystal 15 are different. Thus, in multiple bandpass mode, the phase retardation profile δ₁ of the first channel is not equal to the phase retardation profile δ₂ of the second channel. This is because of the different degree of axial twist of the light 17 that passes through the first liquid crystal 12 versus the light that passes through the second liquid crystal 15. When this occurs, the second term of

$$\frac{1}{2} {sin}^{2} ( \frac{δ 1 - δ 2}{2} )$$

in Formula 4 will contribute to the final transmittance profile. When the voltages and thereby the phase retardation profiles δ₁ and δ₂ are adjusted, the multiple bandpass mode of the MCF can permit “white” light and/or other kinds of complex spectral bands to pass through the MCF.

The wavelengths of light that are useful in the MCF of the disclosure are not limited. In some embodiments, the wavelengths of light that are passed through the MCF include ultraviolet (UV), visible (VIS), near infrared (NIR), visible-near infrared (VIS-NIR), shortwave infrared (SWIR), extended shortwave infrared (eSWIR), near infrared-extended shortwave infrared (NIR-eSWIR). These classifications correspond to wavelengths of about 180 nm to about 380 nm (UV), about 380 nm to about 720 nm (VIS), about 400 nm to about 1100 nm (VIS-NIR), about 850 nm to about 1800 nm (SWIR), about 1200 nm to about 2450 nm (eSWIR), and about 720 nm to about 2500 nm (NIR-eSWIR). The above ranges may be used alone or in any combination of the listed ranges. Such combinations include adjacent (contiguous) ranges, overlapping ranges, and ranges that do not overlap.

In each of single bandpass mode and multiple bandpass mode, the voltage that is applied to one or more of the liquid crystals in the MCF is not limited. In some embodiments, the voltage applied to one or more of the liquid crystals during single bandpass mode or during multiple bandpass mode is about 0.5 V, about 0.6 V, about 0.7 V, about 0.8 V, about 0.9 V, 1.0 V, about 1.1 V, about 1.2 V, about 1.3 V, about 1.4 V, about 1.5 V, about 1.6 V, about 1.7 V, about 1.8 V, about 1.9 V, about 2.0 V, about 2.1 V, about 2.2 V, about 2.3 V, about 2.4 V, about 2.5 V, about 2.6 V, about 2.7 V, about 2.8 V, about 2.9 V, about 3.0 V, about 3.1 V, about 3.2 V, about 3.3 V, about 3.4 V, about 3.5 V, about 3.6 V, about 3.7 V, about 3.8 V, about 3.9 V, about 4.0 V, about 4.1 V, about 4.2 V, about 4.3 V, about 4.4 V, about 4.5 V, about 4.6 V, about 4.7 V, about 4.8 V, about 4.9 V, about 5.0 V, about 5.1 V, about 5.2 V, about 5.3 V, about 5.4 V, or about 5.5 V. Of the above values, the disclosure contemplates that ranges can be formed from at least two of the above-listed voltages. Furthermore, while the voltages between two liquid crystals must be substantially equal in order for the MCF to operate in single bandpass mode, the voltages must be different when the MCF is deployed or configured in multiple bandpass mode.

### Example

A multi-conjugate filter was constructed and the transmittance spectra for each channel were modeled. The modeling simulated the independent application of voltage in the range of 1.0V to 4.8V to each channel of the MCF with a 10 mV step size. The modeling also simulated, at wavelengths between 800 nm to 1800 nm, the transmittance of light through the channel and/or the MCF. Thus, the transmittance was plotted as a function of the wavelength of the incoming light.

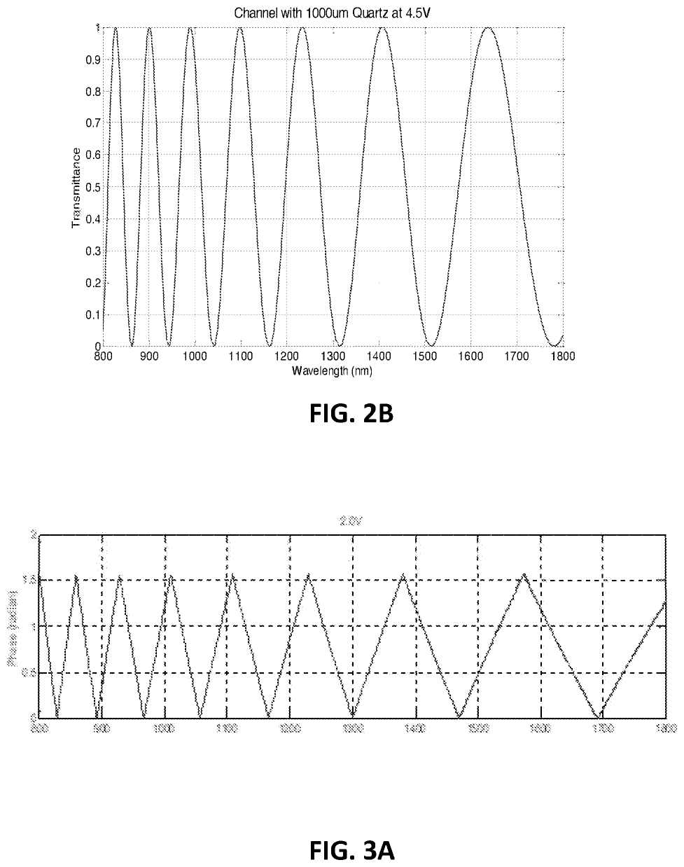

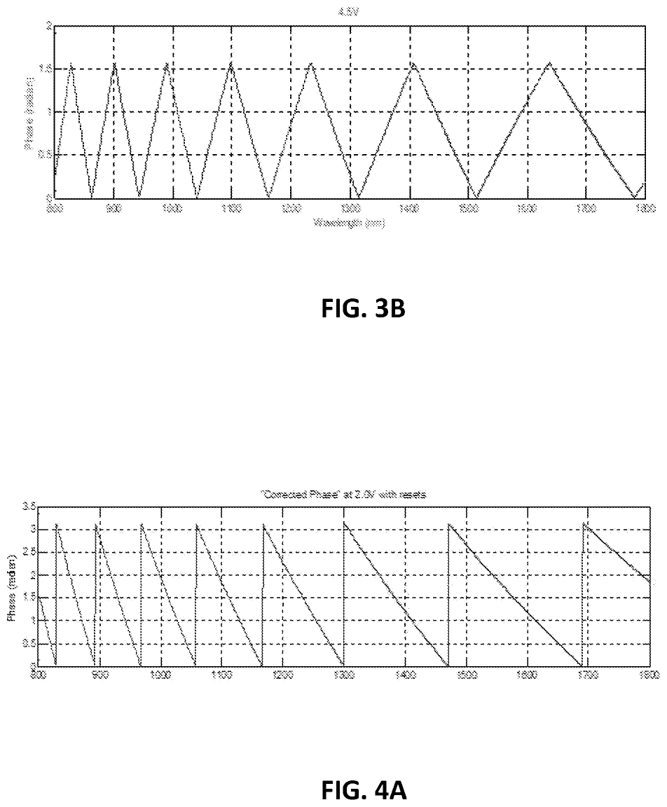

FIG. 2A shows the model results for a voltage of 2.0 V applied to the two liquid crystals of a channel of the MCF, where each channel includes a 1000 μm quartz retarder. FIG. 2B shows the model results for a voltage of 4.5 V applied to the two liquid crystals of a channel of the MCF, where the channel includes a 1000 μm quartz retarder. FIG. 3A shows the phase profile of the model results for a voltage of 2.0 V applied to the liquid crystals of a channel of the MCF which includes a 1000 μm quartz retarder. FIG. 3B shows the phase profile of the model results for a voltage of 4.5 V applied to the liquid crystals of a channel of the MCF which includes a 1000 μm quartz retarder. FIG. 3A and FIG. 3B are uncorrected.

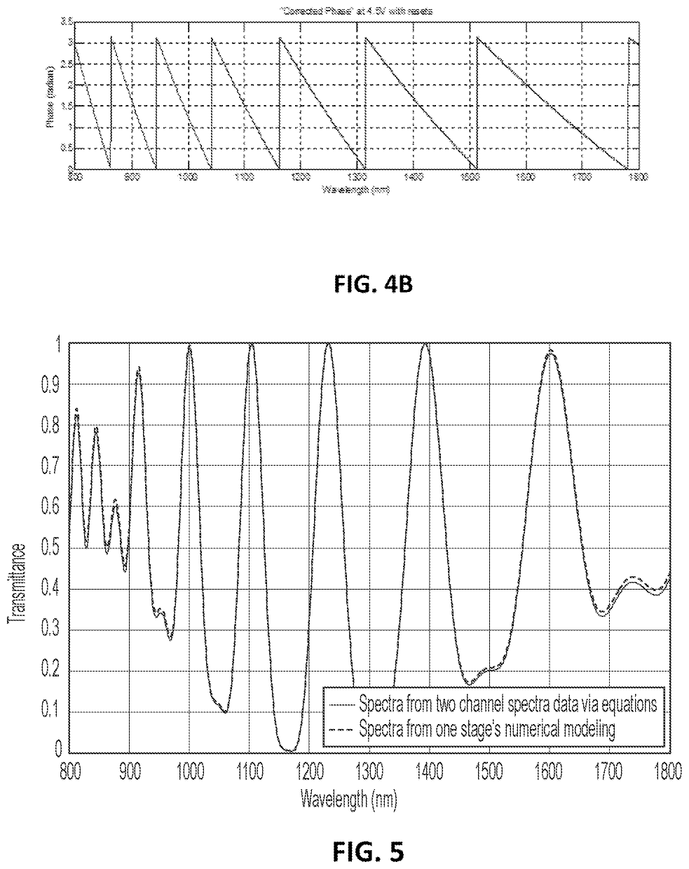

The simulation also considered corrections of the phase profile. The simulated corrected phase profile from applying a voltage of 2.0 V to the liquid crystal of a channel of the MCF is depicted in FIG. 4A. The simulated corrected phase profile from applying a voltage of 4.5 V to the liquid crystal of a channel of the MCF is depicted in FIG. 4B. Finally, after mathematical correction operations to the phase profiles and combining the information from the two channels operated at 2.0 V and 4.5 V, the spectral transmittance versus wavelength was plotted in FIG. 5

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of operating a multi-conjugate filter, wherein the multi-conjugate filter comprises a first channel and a second channel, the method comprising:
applying a first voltage to a first liquid crystal in the first channel, wherein the first channel corresponds to a first optical axis, wherein the first voltage causes the first liquid crystal to exhibit a first phase retardation profile;
applying a second voltage to a second liquid crystal in the second channel, wherein the second channel corresponds to a second optical axis that differs from the first optical axis, wherein the second voltage causes the second liquid crystal to exhibit a second phase retardation profile, wherein the first voltage is different than the second voltage; and
allowing a spectral band of light to pass through the multi-conjugate filter based on the first phase retardation profile and the second phase retardation profile.

2. The method of claim 1, wherein the first voltage is from about 0.5 V to about 5.5 V.

3. The method of claim 2, wherein the second voltage is from about 0.5 V to about 5.5 V.

4. The method of claim 1, further comprising:
applying a third voltage to the first liquid crystal and the second liquid crystal.

5. The method of claim 4, wherein the third voltage is about 0.5V to about 5.5V.

6. The method of claim 1, wherein the first liquid crystal and the second liquid crystal are arranged sequentially.

7. The method of claim 1, wherein the spectral band of light corresponds to white light.

8. The method of claim 1, wherein each of the first channel and the second channel comprises a retarder aligned with the first liquid crystal and the second liquid crystal, respectively.

9. The method of claim 1, wherein the second optical axis is the inverse of the first optical axis.

10. The method of claim 9, wherein the first optical axis is +23° and the second optical axis is −23°.

11. A multi-conjugate filter comprising:
a first channel comprising a first liquid crystal, wherein the first channel corresponds to a first optical axis; and
a second channel comprising a second liquid crystal, wherein the second channel corresponds to a second optical axis that differs from the first optical axis;
wherein the first liquid crystal is configured to exhibit a first phase retardation profile in response to the first voltage and the second liquid crystal is configured to exhibit a second phase retardation profile in response to the second voltage, thereby causing the multi-conjugate filter to permit a spectral band of light to pass therethrough based on the first phase retardation profile and the second phase retardation profile.

12. The multi-conjugate filter of claim 11, wherein the first voltage is from about 0.5 V to about 5.5 V.

13. The multi-conjugate filter of claim 12, wherein the second voltage is from about 0.5 V to about 5.5 V.

14. The multi-conjugate filter of claim 11, wherein the first liquid crystal and the second liquid crystal are arranged sequentially.

15. The multi-conjugate filter of claim 11, wherein the spectral band of light corresponds to white light.

16. The multi-conjugate filter of claim 11, wherein each of the first channel and the second channel comprises a retarder aligned with the first liquid crystal and the second liquid crystal, respectively.

17. The multi-conjugate filter of claim 11, wherein the second optical axis is the inverse of the first optical axis.

18. The multi-conjugate filter of claim 17, wherein the first optical axis is +23° and the second optical axis is −23°.
